(19) United States
(12) Patent Application Publication
(10) Pub. No.: US 2012/0135385 A1
(43) Pub. Date: May 31, 2012

(54) ORAL COMPOSITION AND METHOD FOR ENHANCING TASTING CAPABILITY AND TASTING INTELLIGENCE

(76) Inventor: Seh-Huang CHAO, Taipei City (TW)

(21) Appl. No.: 13/306,121

(22) Filed: Nov. 29, 2011

(30) Foreign Application Priority Data
Nov. 30, 2010 (TW) 99141579

(51) Int. Cl. A23L 1/226; G09B 19/00

(52) U.S. Cl. 434/127; 426/650; 426/89

(57) ABSTRACT

An oral composition and a method for enhancing tasting capability and tasting intelligence involve applying the oral composition of a specific design to a user's mouth, wherein the specific design comprises allowing the oral composition to release successively one or more stimulating factors in the user's mouth over time; allowing the oral composition to provide the user with an innovative tasting experience constructed from music-like, graduated, rhythmic tasting and mouthfeel while the stimulating factors successively dissolve in and release to the user's mouth in a predetermined manner; and conducting diagnosis, training and/or enhancement of tasting capability and/or tasting intelligence of the user based on the user's individual music-like, graduated, rhythmic tasting and mouthfeel.

### BACKGROUND OF THE INVENTION

1. Technical Field

The present invention relates to an oral composition and a method for enhancing tasting capability and tasting intelligence. The oral composition is designed to give eaters thereof an innovative experience of graduated, rhythmic tasting and mouthfeel, like listening to music, so as to enhance joy of tasting and improve the eaters' sensibility, discrimination, association and intelligence related to tasting.

2. Description of Related Art

The present invention herein introduces the innovative concept of “tasting intelligence”, which can be understood as the way we understand the traditional definition of “intelligence” except that “tasting intelligence” is particularly related to human capability of identifying, recognizing and appreciating the flavors of edible substances. It is known that human brain is a highly developed organ with advanced functions for doing measuring and/or rating in various conceptual fields, including language, communication, compute, logic, detection, discrimination, linkage, determination, comprehension, memory, association, creation and more. The ability to do so is referred to as intelligence. In today's civilization, there have been many forms of intelligence-improving training and education designed for children and adults, respectively. Such training and education are typically conducted and measured by way of human vision and hearing. Throughout existing literature and presentations, neither training nor education in intelligence by way of tasting has been addressed.

People use techniques such as processing, cooking, extracting and preserving to treat foods and learn from the resultant tasting experiences whether a flavor is delicious or not. When eating, a person mentally determines that he/she likes or dislikes a food based on his/her past tasting experiences while being physically satisfied with the nutrition and calories provided by the food. The occurrence and disappearance of taste stimulation are approximately simultaneous with the food's entry into and exiting from the mouth, respectively. Between its occurrence and disappearance, the taste stimulation generated by a bite of food typically gives a consistent single or combined flavor. The inventor has thus noted that there has never been found a food giving a music-like, rhythmic and melodious taste.

With vigorous growth of food industry, many types of foods have been developed. Although some recently developed food products feature multi-layer structure, they are not designed to be rhythmically dissolved in a human mouth or to give a song-like feeling or testing experience.

Human musical sense is typically fostered from listening and touching experiences, not tasting experiences. In modern educational system, teaching and learning music is widely accepted as a universal value, because it is commonly recognized that music is beneficial to human health in both mental and physical aspects. The inventor thus considers introducing the value of music into the field of taste, for using the concept of music to calibrate or improve human tasting capability.

Training for tasting capability has been seen in a few professional fields, such as wine tasting, cook training, way of tea and coffee tasting. However, these professional fields are not related to the musical percipience for foods and lack for a set of evaluation criteria understandable to non-professional people. In formal education, there is no training course designed for taste training, and no measurement for people to evaluate and score the achievement of taste training.

Different from musical sense, color sense and touching that have been studied extensively, tasting capability is an untilled area people rarely to assess. Discussion about tasting capability is mainly focused on flavor discrimination, and is less made toward the correlation between individual eating behavior and tasting capability. The inventor believes when talking about tasting capability and tasting intelligence, we should go deeper by considering individual physical and mental reactions and behavioral patterns before and after taste stimulation, individual flavor discrimination, appreciation, attention, sustainability, memory, association, tolerance, restoration, communication, curiosity, desire, satisfaction, possessiveness and other more that may have impact on mental activities, as these are all with the scope of tasting intelligence for the purpose of the inventor's discussion. Before the disclosure of the present invention, there is no tool or method developed for measuring tasting intelligence.

People with adiposity usually eat and drink fast while being distracted, so they tend to unconsciously ingest foods more than needed. In addition, their distraction in the course of eating can significantly lower their sensibility to or satisfaction with foods. It has been demonstrated that people eat not only for absorbing the nutrition or calories required for maintaining physical operation mechanism, but also for satisfying themselves mentally with foods. Obesity is therefore partially caused by that low mental satisfaction is achieved by per unit of food, so a person has to take more food until he/she mentally feels satisfied. Bearing this in mind, the inventor has found that among those many existing therapies for weight loss, none is related to improvement or correction of individual tasting capability. Before the inventor's providing the present invention, there is no any approach to weight loss by correcting or training tasting intelligence.

As modern people usually live under high stress, many depend on indulging themselves with foods in order to relieve pressure coming from daily life or work. The sense of taste is one of the senses we easily apply stimulants to. Such an unhealthy desire is also adverse to the environment as resources are wasted unnecessarily. Therefore, more attention should be paid to training and enhancement of tasting intelligence and more effort should be made to develop useful tools for this purpose.

### SUMMARY OF THE INVENTION

The present invention provides a method for enhancing tasting capability and tasting intelligence, the method including:

(a) providing an oral composition of a specific design and applying the oral composition to a user's mouth, wherein the specific design comprises allowing the oral composition to release successively one or more stimulating factors in the user's mouth over time;

(b) allowing the oral composition to provide the user with an innovative tasting experience constructed from music-like, graduated, rhythmic tasting and mouthfeel while the stimulating factors successively dissolve in and release to the user's mouth in a predetermined manner; and

(c) conducting diagnosis, training and/or enhancement of tasting capability and/or tasting intelligence of the user based on the user's individual music-like, graduated, rhythmic tasting and mouthfeel.

Also, the present invention provides an oral composition for enhancing tasting capability and tasting intelligence that comprises:

a main body, containing at least one carrier each having a plurality of different stimulating factors, wherein the stimulating factors are qualitatively or quantitatively different, and the carrier is to be applied to a user's mouth so that the stimulating factors contained therein are released to the user's mouth in a predetermined manner, thereby providing the user with music-like, graduated, rhythmic tasting and mouthfeel.

Tasting intelligence is the innovative concept proposed by the present invention. The primary objective of the present invention is to provide an oral composition that enables training of intelligence to be conducted by means of taste training.

Other objectives of the present invention may be summarized as:

1. Developing a tool for training human tasting capability or intelligence;

2. Providing human with innovative tasting experiences by allowing users to feel music-like, graduated, rhythmic tasting experiences;

3. Promoting the development of tasting intelligence, such as tasting-related language ability, tasting-related rhythmics, tasting-related musical sense, tasting-related attention, tasting-related association, tasting-related memory, tasting-related control ability, tasting-related appreciation, tasting-related creation and so on;

4. Correcting human behavior related to deviated tasting, such as binge eating or picky eating;

5. Providing the public with a convenient tool for enhancing tasting intelligence, so that qualitative and/or quantitative training of tasting intelligence can be easily conducted; and

6. Helping users in relieving pressure by means of stimulation, training and enhancement of tasting intelligence, so that the users can stop depending on their desire to food and prevent from behavior related to deviant tasting, such as binge eating or picky eating.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic drawing showing the oral composition of the present invention having its stimulating factors dissolved in the manner comforting to the pattern of the musical passage;

FIG. 2 illustrates a first concept of the oral composition of the present invention;

FIG. 3 is a schematic drawing showing the oral composition of the present invention covered with a coating;

FIG. 4 is a schematic drawing illustrating how the oral composition according to the first concept of the present invention works;

FIG. 5 is a schematic drawing illustrating the oral composition of the present invention composed of different stimulating factor sets;

FIG. 6 is a cross-sectional view of a second concept of the oral composition of the present invention;

FIG. 7 is a cross-sectional view of a third concept of the oral composition of the present invention;

FIG. 8 is a cross-sectional view of a fourth concept of the oral composition of the present invention; and

FIG. 9 illustrates a fifth concept of the oral composition of the present invention.

### DETAILED DESCRIPTION OF THE INVENTION

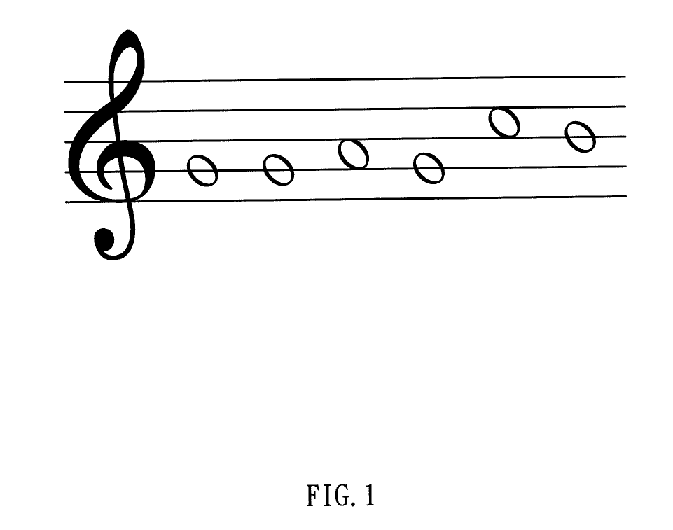

The present invention discloses an oral composition and a method for enhancing tasting capability and tasting intelligence by providing a user with music-like, graduated, rhythmic tasting and mouthfeel. For the sake of convenient explanation, a musical passage is depicted in FIG. 1 for example.

FIG. 1 shows a musical passage as a C-Major scale contains six musical notes. Therein, the first, second and fourth musical notes represent “So”, the third note represents “La”, the fifth note is a high “Do”, and the sixth note represent “Si”. For simulating the musical passage with changes in tasting, four different food elements are used herein for representing the musical notes of four different pitches. Every food element gives a user with a particular kind and/or level of stimulation so different food elements jointly give a user with graduated feeling. For example, a food element with a sweet stimulating factor that is relatively mild, peaceful and pleasing may associate the user to a relatively low musical pitch, so it can represent the lower pitch. On the other hand, a food element bringing about a sour stimulating factor that is relatively strong, sharp and exciting and even suggests that the food is about to become decayed may associate the user to a relatively high pitch, so it can represent the higher pitch. In addition to sourness and sweetness, stimulating factors related to bitterness, spiciness, saltiness and other tastes may be implemented. Under this principle, different stimulating factors can be made from foods of different kinds and levels of stimulation, and provide sensorially detectable differences so as to simulate different musical pitches.

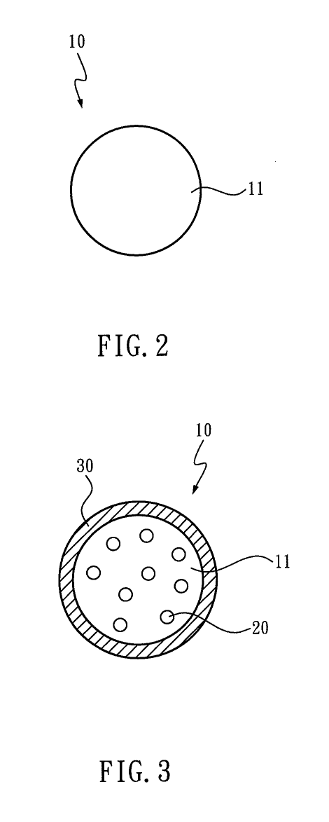

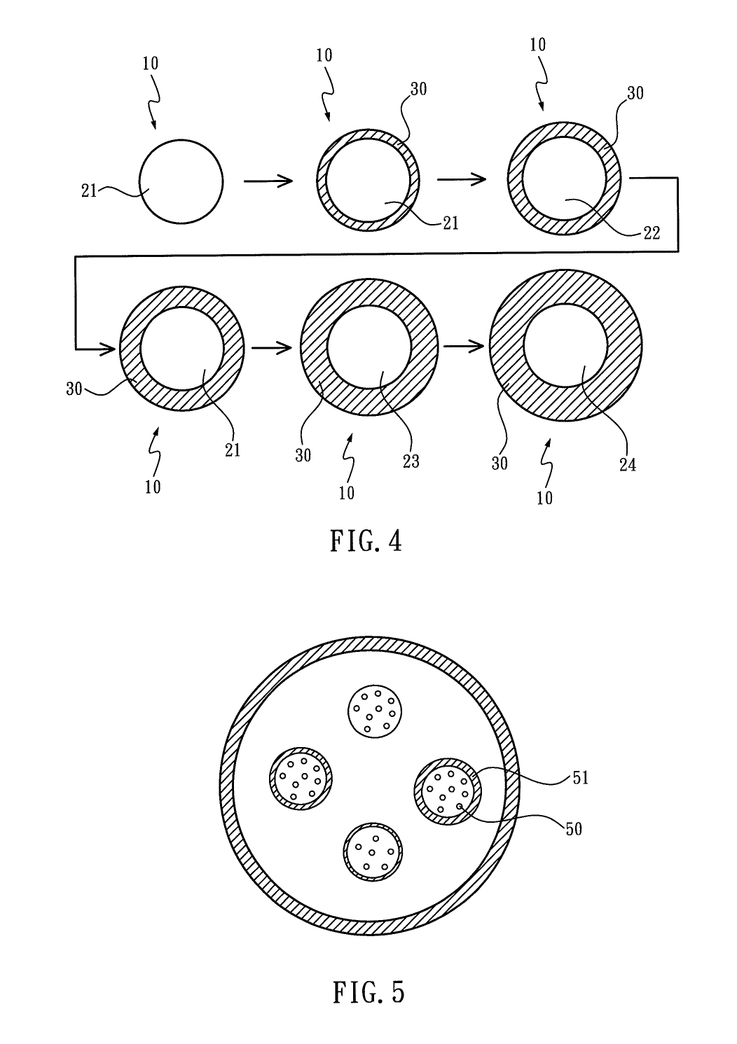

As shown in FIGS. 2 and 3, the oral composition 10 includes a carrier 11, which contains the stimulating factors 20 as described above. Referring to FIG. 4 as well, the stimulating factors 20 can be classified into four kinds based on their detectably different, graduated flavors, namely the “So” stimulating factor 21, the “La” stimulating factor 22, the “Si” stimulating factor 24, and the “Do” stimulating factor 23, for simulating the different pitches as shown in FIG. 1. Meantime, for presenting tasting stimulation simulating the musical passage, the four stimulating factors 20 are scheduled to appear and disappear along a particular course, which is designed under the idea and principle given below.

In the simple musical passage of FIG. 1, all the musical notes have the same time length (duration). Therefore, their levels of stimulation can be finely adjusted to the same. Using levels of stimulation or duration of stimulation, the musical notes having the identical, proper time length can be made. Alternatively, different time lengths of musical notes can be simulated by adjusting different levels of stimulation or duration of stimulation of the stimulating factors.

Since the musical notes are intended to appear in sequence, when the oral composition 10 is applied to a user's mouth, it is important that the stimulating factors 20 representing the musical notes are made with a delayed-release mechanism. As shown in FIG. 3, the delayed-release mechanism may be provided by covering the stimulating factors 20 representing the musical notes with coatings 30 of different thicknesses. Each said coating 30 is necessarily made of a material that brings no impact on the user's sensing the contained stimulating factor 20 when dissolved. The thickness of the coating 30 is set with consideration to the anticipatable and measurable time required for dissolving the coating 30, according to the predetermined schedule and sequence of the stimulating factors 20 to be released. As shown in FIG. 4, the stimulating factors 21, 22, 24 and 23 representing So, La, Si and Do are covered by the coatings 30 of six different thicknesses, thereby forming the oral composition 10 that contains the stimulating factors 20 scheduled to be released at different time points for presenting the six musical notes of FIG. 1.

When the oral composition 10 containing the six stimulating factors 20 starts to dissolve in the user's mouth, the stimulating factors 20 are released successively in the predetermined manner. In particular, the “So” stimulating factor 21 representing the first musical note is made without a coating 30, so that as soon as the oral composition 10 comes to the user's mouth, the stimulating factor 21 representing the first note “So” is directly dissolved and released. After the stimulating factor 21 representing the first note is dissolved out, the coating 30 covering the “So” stimulating factor 21 (representing the second note) is completely dissolved, and release of the “So” stimulating factor 21 is started. Similarly, the stimulating factors 21, 22, 23 and 24 are scheduled to be released in the user's mouth successively, so the overall tasting experience answers to the rhythm of the musical passage. Moreover, the foregoing music-like tasting experience is reproducible by repeatedly applying the oral composition 10 to this or another user's mouth. Such reproducible experience, when experienced by different users, will become a measurable or evaluable subject among the users. For example, a user may describe the tasting experience brought by the oral composition 10 as he/she is describing a musical passage. By comparing individual users in terms of how they can tell the difference between the stimulating factors 20 of the oral composition 10, the users' differentiation capability can be evaluated as simple as their musical appreciation is evaluated.

The foregoing example involves tasting experience simulating a musical passage, and relies on the set of stimulating factors 20 that put into the user's mouth as a bundle. For the purpose of the present invention, the set of stimulating factors 20 is also referred to as a “stimulating factor set”. For releasing the stimulating factor set as a whole, the main body of the oral composition 10 may be in the form of powders incorporating with the carrier 11. Alternatively, a capsule, a tablet or a quasi-tablet may be used. A carrier in any combination of the above-recited forms is also useful.

Each stimulating factor set can give a tasting experience like a musical passage. By connecting different stimulating factor sets, the musical passage can be extended to contribute to a more enriched tasting experience. Furthermore, each said oral composition 10 may contain one or more stimulating factor sets. By releasing the stimulating factor sets one after another in a predetermined manner, the individual musical passages can be connected to a whole tasting experience.

To this end, and to allow identical stimulating factor sets to be released at the same time while different stimulating factor sets are secured from mutual interference, the carrier of the stimulating factor set has to be carefully designed. Referring to FIGS. 3 and 5, the stimulating factor set 50 collects the stimulating factors 20 simulating the same musical passage, and the coating 51 made of a material that brings no impact on the tasting covers the stimulating factor set 50 concentrically. In addition, the stimulating factor sets 50 for giving different tasting experiences are covered by the coatings of differ thicknesses. The coatings 51 of differently thicknesses jointly form a control mechanism to ensure the stimulating factor sets 50 are released properly, so that the musical passages can be successfully linked to provide a more complete tasting experience, thereby enriching the overall tasting experience. The stimulating factor sets 50 associated with the same tasting experience are covered by the coatings 51 of the same thickness, so that the identical stimulating factor sets 50 can be released at the same time.

Alternatively, a single stimulating factor set 50 may contain particles. The particles are configured not to dissolve immediately at the time they are released in the user's mouth. Instead, the particles are dissolved after a period of delaying time. Therein, the same stimulating factor sets 50 have the same length of the delaying time, so that the same stimulating factor sets 50 are released at the same time.

Thereby, the stimulating factor sets 50 associated to different musical passages are released in turn. As a result of such linking, a longer musical sentence can be composed to give a more attractive tasting experience. By repeatedly applying the oral composition 10 to the user, the tasting experience can be reproduced and this allows the user to repeatedly enjoy tasting as he/she enjoys music by replaying it. In this context, the user can repeatedly measure, record, review and discuss his/her tasting experience, in turn evaluating his/her capability of discriminating the stimulating factor sets 50 simulating different musical sentences just like the way he/she evaluates his/her capability of discriminating music.

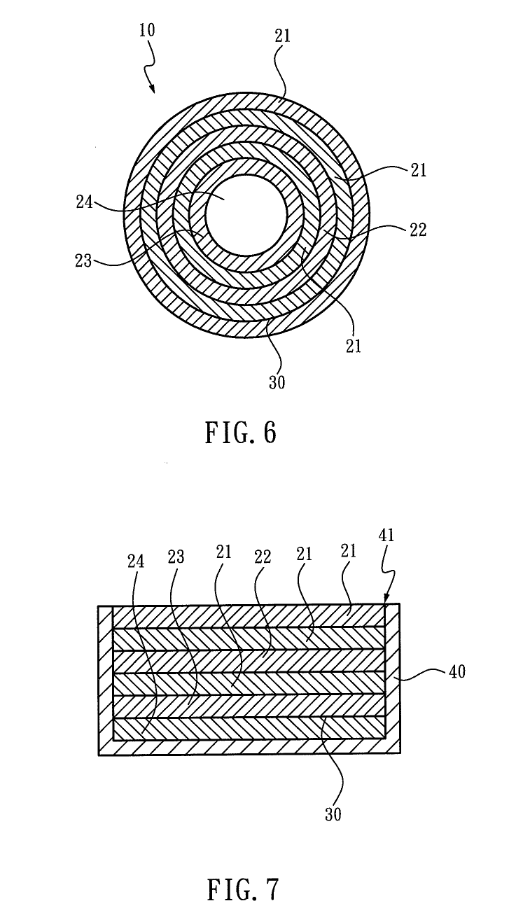

Referring to FIG. 6, this is another concept of the oral composition 10 of the present invention. In this stimulating factor set, the different stimulating factors 21, 22, 23 and 24 are layered according to the intended releasing sequence. For example, in order to express the musical passage of FIG. 1, the outmost layer is the “So” stimulating factor 21, followed inward by the “So” stimulating factor 21, the “La” stimulating factor 22, the “So” stimulating factor 21, the “Do” stimulating factor 23 and the “Si” stimulating factor 24. As the oral composition 10 is dissolved from outside to inside, the stimulating factors 21, 22, 23 and 24 are released in turn as scheduled. The amount/thickness of each said stimulating factor 21, 22, 23 or 24 determines the time length of the musical note it represents. Between the stimulating factors 21, 22, 23 and 24 a coating 30 forming no impact to tasting may be provided, for provide a “staccato” or “rest” effect, so as to give the tasting experience similar to music as described above.

Furthermore, as shown in FIG. 7, instead of the layered structure as previously discussed, the present invention may be realized by a film-based shell 40 that has an opening 41 and filled with stacked stimulating factors 21, 22, 23 and 24. Therein, the film-based shell 40 may be made of a material that brings no impact to tasting and is hardly soluble or has a dissolving rate lower than those of the stimulating factors 21, 22, 23 and 24, so that the stimulating factors 21, 22, 23 and 24 are allowed to dissolved from the outside to the inside and released out via the opening 41. The amounts/thicknesses of the stimulating factors 21, 22, 23 and 24 are designed to reflect the time lengths of the musical notes the individual stimulating factors represent. Between the stimulating factors 21, 22, 23 and 24 a coating 30 forming no impact to tasting may be provided, for provide a “staccato” or “rest” effect, so as to give the tasting experience similar to music as described above.

The oral composition 10 may incorporate more diverse options of food materials, including those producing mouthfeel of different natures, like bubble, impact or intraoral touch/quasi-touch acting on the user's oral mucosa or tongue (e.g. smooth, grained, tingling, etc.), for better simulating the musical characters. Moreover, stimulating factors 20 with different concentrations and/or intensities may be used to express the volume and forte/piano so as to make the present invention more musical. By combining the use of food materials and changes in arrangement and in amount/thickness of the stimulating factors 20, even a symphony can be simulated.

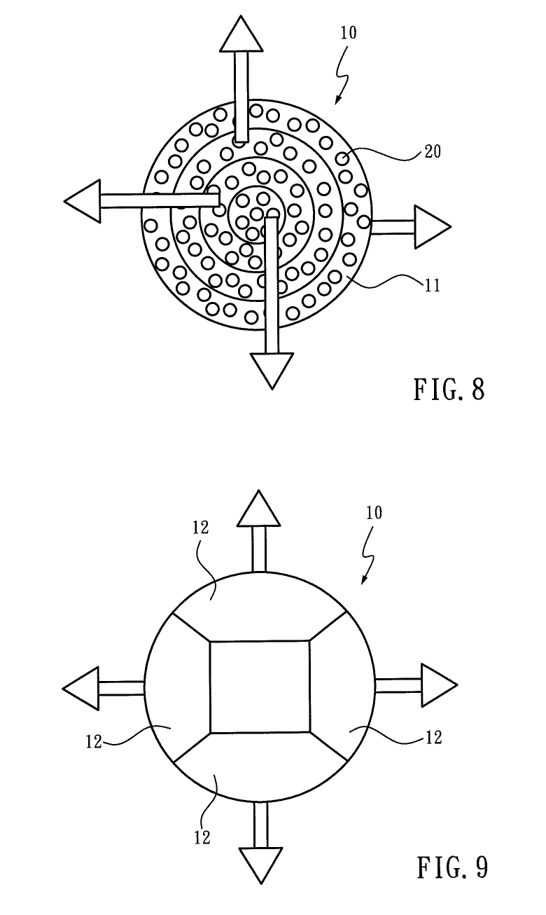

Referring further to FIG. 8, the oral composition 10 may have areas 12 layered or assembled, as FIG. 9. Each of the areas 12 contains stimulating factor sets made of a different food element and has its particular releasing direction, so that the oral composition 10 can release stimulating factors 20 in different directions at the same time, thereby allowing more complex composition of the stimulating factors 20. Therein, the releasing direction may be designed by considering the distribution of taste buds, so as to facilitate tasting tests and training for particular taste bud areas.

With the above concepts, it is clear that the oral composition 10 is able to concentrate its user on feeling and experiencing the flavor in his/her mouth, and is able to repeatedly test user's tasting sensibility, thereby facilitating diagnosis, training and/or enhancement of tasting capability and/or tasting intelligence of the user.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for enhancing tasting capability and tasting intelligence, the method comprising steps of:
(a) providing an oral composition of a specific design and applying the oral composition to a mouth of a user, wherein the specific design comprises allowing the oral composition to release successively one or more stimulating factors in the user's mouth over time;
(b) allowing the oral composition to provide the user with an innovative tasting experience constructed from music-like, graduated, rhythmic tasting and mouthfeel while the stimulating factors successively dissolve in and release to the user's mouth in a predetermined manner; and
(c) conducting diagnosis, training and/or enhancement of tasting capability and/or tasting intelligence of the user based on the user's individual music-like, graduated, rhythmic tasting and mouthfeel.

2. The method of claim 1, wherein the innovative tasting experience is reproducible by repeatedly performing the steps.

3. The method of claim 1, wherein the oral composition has a form selected from the group consisting of powder, particles, a tablet, a quasi-tablet, a capsule and any combination thereof.

4. The method of claim 1, wherein the predetermined manner comprises determining rhythmic dissolution and release of the individual stimulating factors in the user's mouth, and controlling sequence, velocity and duration of the dissolution and release of each said stimulating factor.

5. The method of claim 4, wherein the predetermined manner comprises releasing one or more said stimulating factors simultaneously.

6. The method of claim 4, wherein the predetermined manner comprises allowing the stimulating factors to have different velocity of the dissolution and release.

7. The method of claim 4, wherein the predetermined manner comprises allowing the stimulating factors to produce different kinds of tasting stimulation.

8. The method of claim 7, wherein the different kinds of tasting stimulation comprises sourness, sweetness, bitterness, spiciness, and saltiness.

9. The method of claim 4, wherein the predetermined manner comprises allowing the stimulating factors to generate the mouthfeel in different natures and intensities.

10. The method of claim 9, wherein the mouthfeel comprises stimulation as touch or quasi-touch acting on the user's oral mucosa or tongue.

11. An oral composition for enhancing tasting capability and tasting intelligence, the oral composition comprising:
a main body, containing at least one carrier each having a plurality of different stimulating factors, wherein the stimulating factors are qualitatively or quantitatively different, and the carrier is to be applied to a mouth of a user so that the stimulating factors contained therein are released to the user's mouth in a predetermined manner, thereby providing the user with an innovative tasting experience constructed from music-like, graduated, rhythmic tasting and mouthfeel.

12. The oral composition of claim 11, wherein the different stimulating factors are for producing different kinds of tasting stimulation.

13. The oral composition of claim 11, wherein the different stimulating factors are for generating the mouthfeel in different natures.

14. The oral composition of claim 11, the different stimulating factors are for generating the tasting and mouthfeel in different intensities.

15. The oral composition of claim 11, wherein the main body is composed of a single carrier, and the carrier contains at least one stimulating factor.

16. The oral composition of claim 15, wherein the carrier is covered by at least one coating made of a material that forms no tasting stimulation.

17. The oral composition of claim 11, wherein the main body contains a plurality of carriers each having at least one stimulating factor, and the carriers are concentrically layered with at least one coating arranged therebetween in which the coating is made of a material that forms no tasting stimulation.

18. The oral composition of claim 11, wherein the main body is a film-based shell that has an opening and is filled with stacked carriers each having at least one stimulating factor, in which the film-based shell is made of a material that forms no tasting stimulation and is hardly soluble or has a dissolving rate lower than a dissolving rate of any said stimulating factor, while at least one coating made of a material that forms no tasting stimulation is arranged between the stimulating factors.

19. The oral composition of claim 11, wherein the main body is formed by a plurality of carriers that are concentrically layered as separate areas, in which each said area contains at least one stimulating factor and has at least one releasing direction.

20. The oral composition of claim 11, wherein the main body is formed by a plurality of carriers that are assembled as separate areas, in which each said area contains at least one stimulating factor and has at least one releasing direction.
